(19) United States
(12) Patent Application Publication
(10) Pub. No.: US 2023/0062432 A1
(43) Pub. Date: Mar. 2, 2023

(54) PRIVACY ECOSYSTEM PERMISSION HANDLING

(71) Applicant: ALLSTATE INSURANCE COMPANY, (US)

(72) Inventors: Timothy GIBSON, Barrington, IL (US); Marvin LU, Chicago, IL (US); Thomas J. WILSON, Chicago, IL (US); Aleksandr LIKHTERMAN, Wheeling, IL (US); Raja THIRUVATHURU, Aurora, IL (US)

(21) Appl. No.: 17/863,063

(22) Filed: Jul. 12, 2022

Related U.S. Application Data
(63) Continuation-in-part of application No. 17/587,799, filed on Jan. 28, 2022.
Application No. 17/587,799 is a continuation-in-part of application No. 17/587,815, filed on Jan. 28, 2022.
(60) Provisional application No. 63/239,215, filed on Aug. 31, 2021.
(60) Provisional application No. 63/239,215, filed on Aug. 31, 2021.
(60) Provisional application No. 63/239,215, filed on Aug. 31, 2021.

(51) Int. Cl. H04L 9/40

(52) U.S. Cl. CPC H04L 63/102; H04L 63/105; H04L 63/20

(57) ABSTRACT

A system receives a request to add one or more permissions for a third-party entity to access a privacy vault associated with a user and determine one or more types of contents that are stored by the privacy vault and that the entity intends to access, the determination based on identification of the one or more types of contents by the entity. The system defines a permissions policy applicable to the entity defining permissions relating to access of contents and that encompasses at least permissions relating to access of the one or more types of contents and determines whether the permissions policy falls within user-defined guidelines for automatic acceptance of new permissions policies. Further, system presents the permissions policy to a user for acceptance or modification responsive to the permissions policy falling outside the user-defined guidelines.

### CROSS-REFERENCE TO RELATED APPLICATIONS

This application claims the benefit of U.S. provisional application Ser. No. 63/239,215 filed Aug. 31, 2021, the disclosure of which is hereby incorporated in its entirety by reference herein and is a Continuation-in-Part of U.S. application Ser. No. 17/587,799, filed on Jan. 28, 2022, which claims the benefit of U.S. provisional application Ser. No. 63/239,215 filed Aug. 31, 2021, and is a Continuation-in-Part of U.S. application Ser. No. 17/587,815, filed on Jan. 28, 2022, which claims the benefit of U.S. provisional application Ser. No. 63/239,215 filed Aug. 31, 2021, the contents of each of which are also incorporated in their entirety by reference herein.

### TECHNICAL FIELD

The illustrative embodiments generally relate to permissions handling for, among other things, a privacy ecosystem.

### BACKGROUND

People are becoming ever increasingly aware of the capture and storage of their data and habits discernable from their data. The level of data gathering that occurs has often reached a point where many people may find it intrusive. For example, a company may ask permission to track location in exchange for use of their application on a phone. What that can mean, however, is that they track both location and duration of stay, letting them determine whether a person was eating at a restaurant vs. passing by, or how long someone spent shopping at a store. In the aggregation, this allows companies to build a fairly robust model of an individual's behavior, and that, in turn, can create revenue and advertising opportunities for that company.

There is likely some value to the individual in using the application, in addition to having the data analyzed, but in many cases the bulk of the value of the data is not captured by the person about whom the data was gathered. If the person had control over their data in a more granular manner, they could recapture some of that value and prevent unintended or unknown misuse of their personal data and habits. Even if such services existed, however, there remain challenges to setting up accounts with those services, informing people of the existence of the services, and handling all of the existing agreements that users have with various application providing entities—i.e., a user probably cannot simply cut off access to data for an entity, as such access is often a predicate for using an application provided by the entity.

Moreover, as each entity gathers and uses different data in different manners, arranging and controlling permissioning for all of these various entities can be a time consuming and sometimes overwhelming task. In many instances, users may want to know what data is being gathered and how it is being used, but they may not want the burden of manually controlling permissioning for each application and setting permissions at a granular level. On the other hand, some users may want exactly that, and so there are many obstacles to devising and creating a personal data management system that meets the wildly varying needs of sometimes very disparate users.

### SUMMARY

In a first illustrative embodiment a system includes one or more processors configured to receive a request to add one or more permissions for a third-party entity to access a privacy vault associated with a user and determine one or more types of contents that are stored by the privacy vault and that the entity intends to access, the determination based on identification of the one or more types of contents by the entity. The one or more processors are also configured to define a permissions policy applicable to the entity defining permissions relating to access of contents and that encompasses at least permissions relating to access of the one or more types of contents and determine whether the permissions policy falls within user-defined guidelines for automatic acceptance of new permissions policies. Further, the one or more processors are configured to present the permissions policy to a user for acceptance or modification, responsive to the permissions policy falling outside the user-defined guidelines.

In another embodiment, the identification of the one or more types of contents is provided in an entity usage agreement provided by the third-party entity and wherein the one or more processors are further configured to analyze the usage agreement to determine the one or more types of contents. In still another embodiment, identification of the one or more types of contents is provided via the entity by a representative contents request provided by the third-party entity. In yet a further embodiment, identification of the one or more types of contents is provided via the third-party entity by express identification of specific contents elements the third-party entity intends to access. In another embodiment, identification of the one or more types of contents is provided via a predefined packet identifying specific contents elements that the third-party entity intends to access defined in a predefined format recognizable by the one or more processors.

In a further embodiment, the determination of whether the permissions policy falls within user-defined guidelines is based at least in part on one or more characteristics of the third-party entity correlated to user-defined guidelines defining automatically acceptable new permissions policies for third-party entities having the one or more characteristics.

In yet a further embodiment, the one or more characteristics include a type of business of the third-party entity. In another embodiment, the user-defined guidelines identify classes of contents having varied security levels associated therewith, and wherein definition of the permissions policy includes access to contents at or below a most-secure level associated with at least one of the one or more types of contents.

In a further embodiment, the user-defined guidelines identify classes of contents having varied security levels associated therewith, and wherein definition of the permissions policy includes access to contents below a most-secure level associated with at least one of the one or more types of contents and further includes access to specific contents at the most-secure level limited to specific types of contents based on the identification of the one or more types of contents.

In an additional embodiment, the user-defined guidelines identify types of contents accessible by types of business associated with third-party entities, and wherein definition of the permission policy includes access limited to the specific one or more types of contents identified by the third-party entity.

In another illustrative embodiment, a method includes receiving a request to add one or more permissions for a third-party entity to access a privacy vault associated with a user and determining one or more types of contents, stored by the privacy vault, that the entity intends to access, based on identification of the one or more types of contents by the entity. The method also includes defining a permissions policy applicable to the entity defining data permissions relating to access of contents and that encompasses at least permissions relating to access of the one or more types of contents and determining whether the permissions policy falls within user-defined guidelines for automatic acceptance of new permissions policies. Further, the method includes presenting the permissions policy to a user for acceptance or modification, responsive to the permissions policy falling outside the user-defined guidelines.

In a further embodiment, identification of the one or more types of contents is provided in a third-party entity usage agreement provided by the third-party entity and wherein the one or more processors are further configured to analyze the usage agreement to determine the one or more types of contents. In another embodiment, identification of the one or more types of contents is provided via the third-party entity by a representative contents request provided by the third-party entity. In an additional embodiment, the identification of the one or more types of contents is provided via the third-party entity by express identification of specific contents elements the third-party entity intends to access. In a further embodiment, identification of the one or more types of contents is provided via a predefined packet identifying specific contents elements that the third-party entity intends to access defined in a predefined format.

In another embodiment, the determination of whether the permissions policy falls within user-defined guidelines is based at least in part on one or more characteristics of the third-party entity correlated to user-defined guidelines defining automatically acceptable new permissions policies for third-party entities having the one or more characteristics. In a further embodiment, the one or more characteristics include a type of business of the third-party entity.

In still a further embodiment, the user-defined guidelines identify classes of contents having varied security levels associated therewith and definition of the permissions policy includes access to contents at or below a most-secure level associated with at least one of the one or more types of contents. In an additional embodiment, the user-defined guidelines identify classes of contents having varied security levels associated therewith, and definition of the permissions policy includes access to contents below a most-secure level associated with at least one of the one or more types of contents and further includes access to specific contents at the most-secure level limited to specific types of contents based on identification of the one or more types of contents.

In a further illustrative embodiment, a system includes a user privacy vault storing a plurality of types of user contents gathered from one or more devices of a user and one or more processors configured to receive a request to add a plurality of permissions granting access to the privacy vault for a plurality of third-party entities. The one or more processors are also configrude to, for one or more of the plurality of third-party entities, analyze information provided by a given of the one or more third-party entities, indicating what contents, of the user contents, the given third-party entity intends to access. The one or more processors are configured to define a new permissions policy for the given third-party entity based on the analyzing and determine if the new permissions policy corresponds to user-defined guidelines for automatic acceptance of a permissions policy. The one or more processors are configured to store the new permissions policy, responsive to the new permissions policy corresponding to the user-defined guidelines, present the new permissions policy to the user for acceptance or modification, responsive to the new permissions policy failing to correspond to the user-defined guidelines, and repeat the analysis, definition of the new policy, determination of correspondence to guidelines and storing or acceptance for remaining ones of the one or more third-party entities.

### BRIEF DESCRIPTION OF THE DRAWINGS

FIG. 1 shows an illustrative example of a personal data vault system, an entity data gathering system and a user personal device;

FIG. 2 shows an illustrative example of a process for account initiation and permission handling upon account initiation;

FIG. 3 shows an illustrative PDV creation and initialization process;

FIG. 4 shows an illustrative process for policy analysis;

FIG. 5 shows an illustrative example of a data-sharing analysis process;

FIG. 6 shows an illustrative example of an alternative policy creation process;

FIG. 7A shows an illustrative data taxonomy;

FIG. 7B shows illustrative base taxonomy examples as a possible interface;

FIG. 8 shows an illustrative example for a classifier; and

FIG. 9 shows an illustrative example of a process that can define an embedded data request in a consistent format.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

In addition to having exemplary processes executed by a first mobile, personal or cloud computing system, in certain embodiments, the exemplary processes may be executed by a second computing system in communication with the first computing system. Either system may include, but is not limited to, a wireless device (e.g., and without limitation, a mobile phone) or a remote computing system (e.g., and without limitation, a server) connected through the wireless device. In certain embodiments, particular components of either system (or additional systems) may perform particular portions of a process depending on the particular implementation of an embodiment or an implementation similar to an embodiment. By way of example and not limitation, if a process has a step of sending or receiving information in conjunction with a wireless device, then it is likely that the wireless device is not performing that portion of the process, since the wireless device would not “send and receive” information with itself. One of ordinary skill in the art will understand when it is inappropriate to apply a particular computing system to a given solution.

Execution of processes may be facilitated through use of one or more processors working alone or in conjunction with each other and executing instructions stored on various non-transitory storage media, such as, but not limited to, flash memory, programmable memory, hard disk drives, etc. Communication between systems and processes may include use of, for example, Bluetooth, Wi-Fi, cellular communication, and other suitable wireless and wired communication usable for both short range and long-range wireless transmission as appropriate for a given implementation.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety and are understood to be examples of types of processes that may be performed to achieve elements of the invention. Additional steps may be added or removed from the exemplary processes as desired and the examples are intended to illustrate, but not limit, aspects of the proposed embodiments and inventive concepts.

With respect to the illustrative embodiments described in the figures showing illustrative process flows, it is noted that a general-purpose processor may be temporarily enabled as a special purpose processor for the purpose of executing some or all of the exemplary methods shown by these figures. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

The illustrative embodiments relate to managing permissions for data handling, gathering and sharing, and contemplate, for example, a user personal data vault, or similar construct, that is a core repository for a user's personal data. An example of such a system is described in detail in co-owned U.S. Provisional Application Ser. No. 63/239,215 filed Aug. 31, 2021, the disclosure of which is hereby incorporated in its entirety by reference herein and is a Continuation-in-Part of co-owned U.S application Ser. No. 17/587,799, filed on Jan. 28, 2022, and of co-owned U.S. application Ser. No. 17/587,815, filed on Jan. 28, 2022, the contents of each of which are also incorporated in their entirety by reference herein.

The incorporated references describe personal privacy vaults that act as central management points, under control of a user and protected by an intermediary gateway. These data vaults may include permissions for each entity that wants to obtain user data or contents stored by the privacy vaults, defining, among other things, what that entity may receive, how that entity may use the data, data retention policies, etc. While discretely defining the permissions for one or two entities may be something a user is willing to do, most users interact with dozens, if not hundreds, of entities that want and use user data. This can include, for example, all applications on a mobile device, tablet, PC, etc., vehicle applications and systems, as well as the providers of the same, search engines, social media accounts, and all the various accounts and plugins for which a user has signed up and with which a user has agreed to share data.

Under present models, the data sharing is often either mandatory or a one-click agreement which the user does not read, because users tend to lack much ability to negotiate these agreements and/or control their data. On mobile devices, for example, applications may ask for use of “location” data, but what that means for a given application may be wildly different. For example, application A may use the data only when the application is active and only for the purpose of providing a coupon if the user is located at a store. The entity providing application A may discard all the other non-shopping location data or may use or sell the additional location data for other reasons or to other entities. Application B may execute near-constantly in the background of the mobile device, and gather much more precise “location” data, including travel paths, types of travel (predicted based on observed speeds), durations of stays, etc.

Both companies may allege that the preceding constitutes “location data,” but a user may not realize what they are agreeing to when they accept the predicates for data gathering, assuming, incorrectly, that all that is being gathered is an immediate GPS location when needed and that if not immediately needed, the data is subsequently discarded. If users knew the depth of what “location” encompassed, many users may choose not to use a given service. Other users may simply want to know what is actually being gathered and done with the data, but may be willing to allow the gathering because they lack alternative options to the service, lack opportunities to negotiate terms, and appreciate the service provided in exchange for the data. Still other users may simply not care.

Regardless of the position of a user, it is reasonably unlikely that every user will want to manually go through an exhaustive list of all aspects of data gathering for each application, manually set precise permissions for gathering, use and storage, and then actively monitor the various entities to ensure compliance. Fortunately, the proposed personal data vault systems, and the like, can make many of these tasks automated. Further, those systems can have both default and entity-specific permissioning, and can provide a user (if the user cares to look) with a great deal of insight into what is being gathered by a given entity and how it is being used. At the same time, those permissions may still need to be negotiated at the onset of a relationship, and when a user signs up for a data vault, especially if the vault is designed to become a barricade protecting the user's data, existing relationships and sharing may still need to be negotiated or the user may lose access to many frequently-used services because those services may be prevented from gathering data.

Many challenges exist to creating such a system, not the least of which are the negotiation and management of varied permissions, incentivizing users and back-end entities to participate, and actively providing security to a user's data in a way that provides personal control over data but that does not interrupt services that the user would like to continue to use. The applications incorporated by reference address a number of these issues, and the instant application addresses at least the ideas of account initiation, permissioning handling, and data monitoring in an additionally in-depth manner. Notions such as, but not limited to, data control and flow, permissioning analysis, management and import, data control, relationship negotiation, etc., are not constrained to use exclusively with personal data vaults and the like, but are described in the context of their use in conjunction with such constructs for reasons of illustration and example, not limitation. It is also appreciated that concepts explained herein are illustrative in nature and may be applicable to other examples also explained herein, and equivalent ideas and examples.

Among other things, the illustrative examples provide illustration of how a user can initiate a personal data vault account, how to handle existing relationships and new relationships, monitoring of user activity to find opportunities for relationships and sharing suitable for handling through a data vault or repository, granular and detailed permissioning, default and automatic permissioning, and at least one illustrative data taxonomy that may make it easier to cohesively manage relationships with a variety of entities whose particular needs and wants may be very distinct from each other.

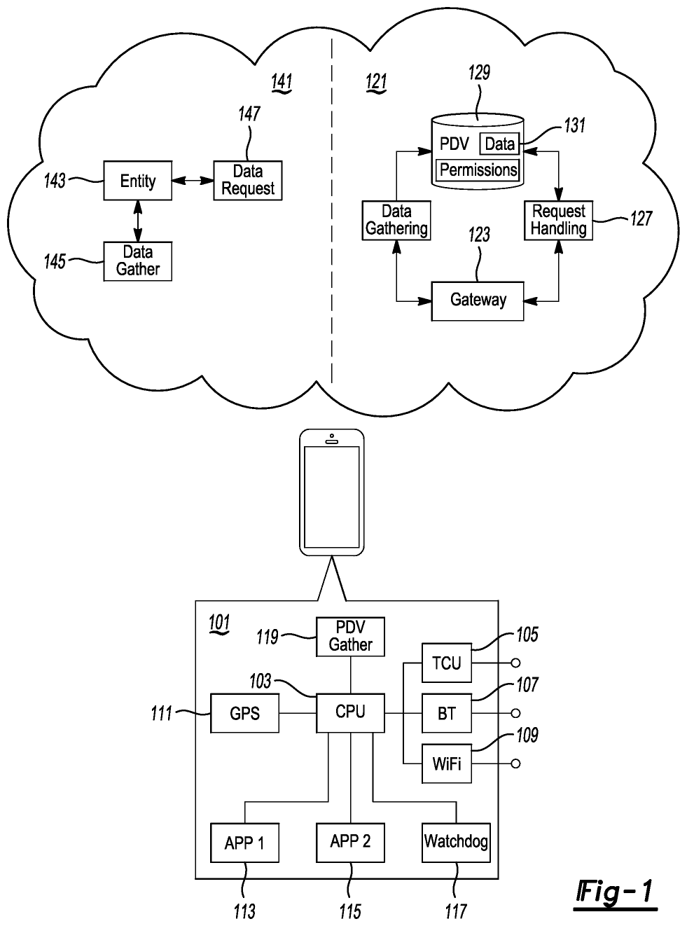

FIG. 1 shows an illustrative example of a personal data vault system, an entity data gathering system and a user personal device. In this example, the user personal device 100 includes a mobile phone, which is a medium usable to gather a great deal of data about a user, as it is frequently used for navigation, recreation, entertainment, system control, shopping, browsing, etc., and it tends to be within reach of a user at virtually all times of the day. Mobile phone usage has become so expansive in capability and so commonplace in all aspects of life that the mobile phone has effectively become a highly sophisticated tracking device that could be used to build a very complete snapshot of a person's routines and behaviors.

Of course, many people would prefer that faceless entities do not have such granular models of their personal behavior and habits, but modern paradigms lack many alternatives to simply agreeing to let the data gathering continue—i.e., it is infrequent that an application will provide, for example, a cost-based version of itself in exchange for agreeing to gather no data except that which is expressly needed for functioning of the application.

In the illustrative phone 100 shown, an onboard computing system 101 includes one or more processors 103 and a number of communication transceivers. In this example, those include a cellular antenna 105, a BLUETOOTH transceiver 107, a Wi-Fi transceiver 109, etc. Each of these communication mediums is a potential outflow point for data, and each can also receive information (cellular signals, BLUETOOTH signatures, local Wi-Fi networks) that can be used to further model a user and track their travel and interaction habits. The device may also include a GPS 111 receiver or other coordinate-based receiver, which is an express way of obtaining specific location information about both the immediate location of the phone (and presumably the user) and how long the phone has remained in that location. Moreover, cross referencing location with real-world map data can lead to conclusions about user activity, whether a phone is carried at all times or frequently left lying around, etc.

Applications 113, 115 on the phone may have express permission or umbrella permission to gather, retain and transmit certain types of data. Agreement to these permissions is often a predicate to usage of an application, and the application may have permission to gather data when active, in the background, etc. Applications may also often be left executing on a mobile device, so that data gathering even when the application is active may be a near ongoing process, if, for example, the user uses the application so frequently that they just tend to leave it active.

The illustrative embodiments include, for example, a watchdog process 117 and a personal data vault (PDV) data gathering process 119. These may be part of the same application or disparate applications, and they may further be background processes or even included in an operating system or executing as plug-ins to one or more other applications.

The watchdog process can, for example, track data gathering that occurs on the phone and/or data storage that occurs on the phone, and may also have permissions similar to a firewall, where it can observe traffic to and from the phone, which may include the destinations associated with data and origins of requests for data. With user permission, this process could effectively monitor ongoing data gathering, at least to some extent, and provide a user with control over what was gathered as well as insight into the comprehensive aggregate of what was gathered. The process may have access to a remote list of permissions (which may also be stored locally on the phone 100) that define which entities, applications, processes, etc. can gather, store and share what data, and it can generally fill a role in monitoring the flow of such data so that the user is assured that data gathering is occurring in a manner more consistent with user desires.

The PDV gathering process 119 may gather duplicate data to that being gathered by some or all other processes and may also gather additional data that a user wants to add to a data vault. In some models, it may even be possible to have the PDV process serve as the exclusive permissioned entity for gathering and storing data, requiring that all requests for such data be handled through the user's PDV, which would be a very robust defense against any impermissible or undesired data gathering.

The PDV process 119 may gather the duplicate data so that various services and entities can still receive the data that they desire and to which the user has agreed. That is, the PDV may be a repository for such data, and even if the user cannot immediately prevent an application from gathering certain data, because of existing agreements and developer desires, the user may also build a repository of such data so that, at a time when the user can wrest control from the developer, the developer is not necessarily prevented from fulfilling their desired data gathering, but rather must negotiate obtainment of such data from the user PDV with more granular user control. A number of process may desire the same data, and in that instance the PDV can also reduce bandwidth usage, being a single point-source for the desired data and allowing data gathering requests to be handled in the cloud as opposed to interfacing directly with the device 100. Because the PDV can also gather factual information about the device 100, such as application usage, it may even be possible to provide an application with a facsimile of “permission while active” data gathering, wherein the data to which the application is entitled by agreement is provided on the predicate that a record, observed by the PDV, indicates that the application was active at the same time that the requested data, which may be timestamped among other things, was gathered.

In the cloud, a PDV system 121 serves as the data warehouse and control center for the user to personally manage, protect and extract value from their own personal data. A gateway 123 can handle all data gathering 125 from the PDV gathering processes, routing the data to the appropriate PDVs 129 corresponding to a given user for whom the PDV process 119 was executing. The gateway may further handle data requests 127 from entities and applications. These requests may be sent directly to the gateway from another entity system 141, or could come from an application residing on a user device 100.

The PDV(s) 129 for a given user may include, for example, a vast library of user personal data 131, as well as permissions 133 defined for all entities that the given user has defined as permitted to access that user's data. The entities may have to negotiate value exchanges for certain data, and in other instances the permissions may be obtained on the basis of the user using a desired service or application. Entities lacking permissions for certain data or a certain user in general may be prohibited from accessing that data or that user's data, and users can begin to obtain control over their data in a manner not previously possible.

Entity systems 141 may historically have gathered data 145 through direct interaction with a user device 100 or with an application 113 residing on such device 100. The entity system 141 may include a variety of backend services and analysis 143, much of which has historically been completed opaque to a user. That is, the user may see some result on their device 100 that was derived on the basis of gathered data, but the user has no real knowledge of how else the data was used, what specific data was used to derive the result, what other data was gathered and used for what other purposes, and how much of any of the data was retained and/or linked personally to the user in an identifiable manner. This lack of transparency has lead to a great deal of recent concern among the general population, and constructs such as the personal data vault can go a long way towards assuaging that concern, especially if users are able to direct future data requests 147 through their personally controlled vault 129, and thus act in some manner as the gatekeepers to something that rightfully belongs to those users in the first place.

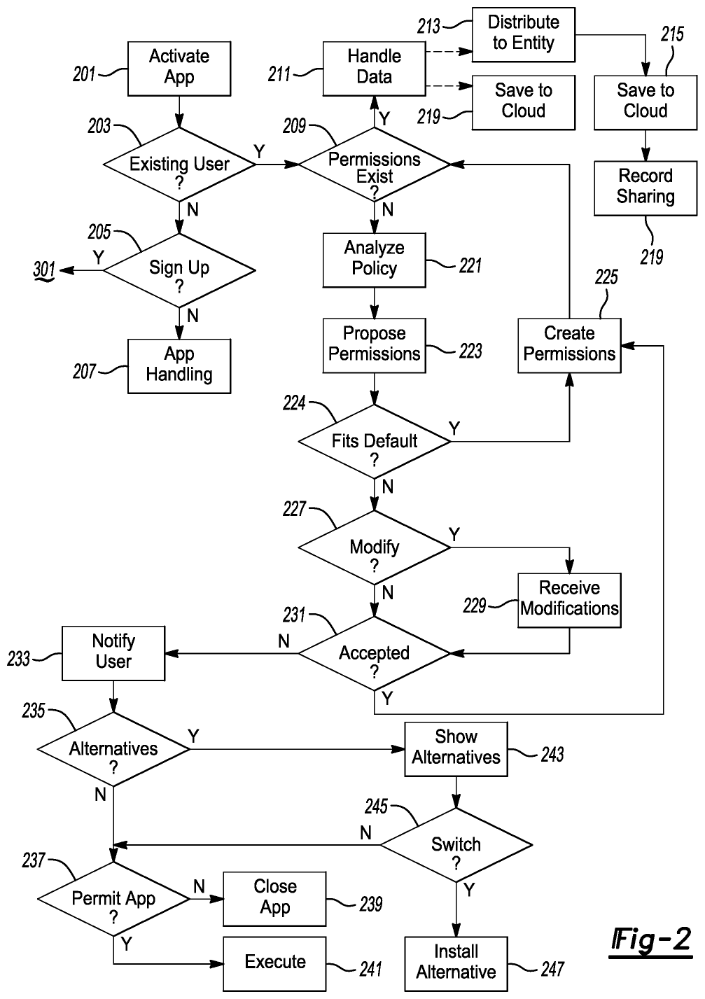

FIG. 2 shows an illustrative example of a process for account initiation and permission handling upon account initiation. In this example, a user may activate an application at 201, which can include an option to sign in using a PDV account, or to create a PDV account to monitor data gathering of the application. If the user has a background PDV watchdog process executing, or if such a process is part of the operating system of a user device, the user may be able to be notified any application not governed by a PDV agreement or policy is activated, installed or otherwise seeks to gather data using a user device.

The activated application may be any application, and as a sign in option, the user may be presented with an option to sign in using a PDV account, or to create a PDV account for sign-in. Unless the option is presented from an outside source (e.g. a watchdog or alternative process), the application developer may need to be partnered with the PDV provider to present the option. But, once sufficient user data is stored in the PDV, the application developer has significant incentive to partner with the PDV provider to access the historical user data, if permitted by the user.

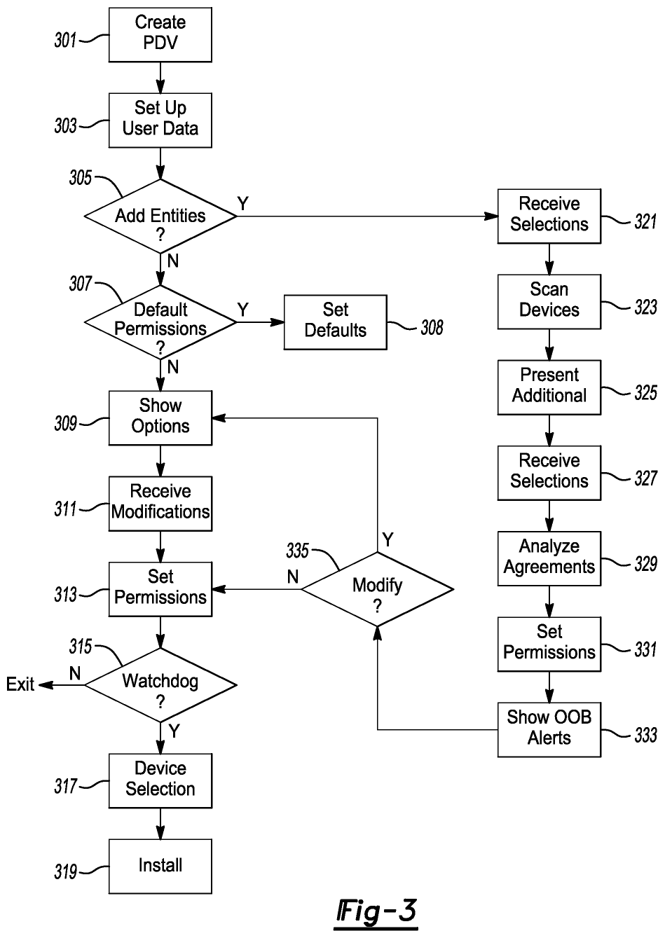

If the user does not have a PDV account at 203, the user may be given an option to sign up for a PDV account at 205. If the user declines, the application will execute at 207 without any interference from the PDV or similar processes. If the user accepts, the process can branch to a sign up process described in greater detail with respect to FIG. 3, or a similar process.

If the user already has an account at 203, or once the user has an account set up, the process will determine if permissions or policies exist for the launched application at 209. If there is a defined set of permissions, then the process can handle data gathering requests from the application or an entity associated with the application in accordance with the defined policy at 211. For example, requested data could be gathered by the device 100 and shared with the entity or application at 213 as well as sent and saved to the PDV at 215. In other instances, the entity may be required to request data to which it is entitled from the PDV, and so the process may save all the requested data to the PDV 219 and the entity can request it from there. While entities may initially resist the second model, it may be better for the user because then the user knows exactly what data the entity is requesting and can have better assurances about control over that data, as well as protecting against data requests when the application is not supposed to be gathering data, for example.

When there are no permissions for the entity or application at 209, the process may analyze a data-gathering policy of the entity at 213. This can include using Artificial Intelligence (AI) and/or Machine Learning (ML) to review contractual or policy language. Potentially problematically, most such agreements are not unified in nature, and are written by an attorney or other representative of the application developer, meaning that each may vary in language choice and completeness of description. Once the PDV has an agreement with a given entity related to a given application (e.g., an agreement with a company called Company A to share data based on use of Company A′s Cartographic application), the PDV will likely have reasonable knowledge of what data is involved in the sharing requests for use of that application. So, unless the user is a first user to request usage of an application, the PDV process may be able to define the boundaries of what data is requested by reference to historical requests observed by the PDV backend.

When the application is new, the PDV process may also request a sample data request from the application developer, if the data gathering policy is unclear on any points. For example, the developer's policy may state that they gather location data, but be no more specific than that. The PDV process may ask what types of data are considered location data, how the data is used, retained, etc. Or the sample data request from the entity or application may answer some or all of those questions. Even a very sophisticated AI process will not know that there is some additional meaning attached to the word “location,” however, so instructing the entity or application to deliver a sample data gathering request may be useful regardless of how the policy language is analyzed.

Once a set of data that will be gathered by the application or entity has been determined, the process can propose a set of permissions at 223. In one example, there are four generalized tiers of permission, and data is categorized (automatically or by a user or PDV provider) into correspondence with a tier. For example, tier one may be the least restrictive and may be correlated to information such as thermostat settings or device usage. Tier two may include more personal information such as basic location data (e.g., destinations without durations or travel times). Tier three may include detailed location information, shopping habits, etc. Tier four may include highly personal data that users would likely only share with financial institutions and highly trusted accounts. While these are merely examples, they are illustrative of how data can be broken into tiers.

Since each application or developer may want different data, the requested data may not always fit neatly into a tier. For example, a developer may want basic shopping data (e.g., where a user shops, but not how much was spent or what was bought) and fuel purchase data of a more detailed nature. Basic shopping data may be correlated to tier two, and detailed fuel purchase data may be correlated to tier three. Since the request includes at least some tier three data, the request may be classified as a tier three permissions request.

In a model where specific data types or elements are not individually permissioned, an entity with tier three permissions may be able to access any tier three data. Many users are unlikely to want to granularly monitor ongoing data requests, and so granting tier three access provides the developer rights to all the data the developer purports to want. If a user is not particularly cautious about their data, they may have a default setting of tier three—i.e., any requests for tier three or below are granted at the corresponding requested level. Another user may only have tier two as the default, so the example developer would be automatically granted access to the first user's data based on the default policy at 224, but not the second user's data.

As discussed later herein, it is possible to grant tier three access but also limit the requests to certain tier three data, but for the default model discussed above and the present example, the initial decision for automatic permissioning may be triggered based on the type of data requested and its correspondence to a default tier. If users can classify their own data, it is also possible that while both example users above have different default access levels, the second user may have the fuel purchase data classified as tier two data, and therefore both requests would be granted at the corresponding respective permission levels. That is, for the second user, the developer would only get tier two access, but that would be sufficient for the developer to obtain the required data from that user because that user had the requested data classified as tier two or lower. When the default permission scheme is met, i.e., when the permission can be granted with no user interaction, the process creates the policy for that developer in the PDV and allows the application to execute. The developer can then either gather data directly from the device in accordance with the permissions, or request the permitted data from the PDV.

If the default model is not met, using the second user above, then the user may be requested to either modify the classification of the requested data—i.e., change the fuel data to tier two, or to modify the policy to create a carve-out policy. In the former example, the user may not want to reclassify the data type or similar data types, and so may elect the latter example, which is to create a modified hybrid policy granting tier two access+fuel purchase data as requested. That way, while the developer can access the specifically requested tier three data type, no other tier three data can be accessed based on the tier two permissioning policy assigned to that entity or application. The user may input the modifications at 229, which could also include a modification that attempts to modify the request to exclude the tier three fuel data, but the developer may have to approve that request.

Once all parties have approved any modifications and accepted any changes at 231, the policy can be created. The process may also automatically propose the hybrid policy at 229 and the user can accept or reject the proposed policy at 231. If the policy is rejected, the user may be notified that the application may become non-functional because the required data is not being shared, at 233. At the same time, the process may determine some comparable alternatives at 235. For example, if the application in question above was an first fuel finding Application A, that application may suggest or create fuel purchase deals when a user is out shopping (hence the requested data). But, there may also be a comparable Application B that provides similar services, but which only requests tier two level shopping and fuel data. For the second user, this would be a preferable application, and the process could recommend this application as an alternative at 243.

On the other hand, the application may be a fuel-source specific application for a specific fuel station chain, and the user may have rewards with that chain and not want to shop elsewhere for fuel. In that instance, there may not be a comparable alternative at 235. At 237, the user may be given the opportunity to permit the application to function. Since the application will function to gather data from the phone, but lack permissions to the PDV, the application can still operate as always on the mobile device (or other device), but may not be able to access the PDV, or may be able to access the PDV with less than full rights. This may be preferable to a user, who may not want the application to have full tier three access to the data stored in the PDV, but may still be willing to let the phone spot-gather data as prior to the PDV in exchange for the value provided by the application. If the developer wanted full tier three access to the PDV, the developer may have to negotiate with certain users to exchange more value for such access, as such access may create much greater opportunity for data. Alternatively, the developer may pare back the data request, preferring tier two PDV access that grants access to all tier two data, as opposed to no PDV access and being restricted to only the data the application is configured to gather from the device.

If the user permits execution at 237, the application is allowed to execute as it had prior to the watchdog application interference at 239, otherwise the watchdog process may terminate the application at 241. If the user prefers an alternative application at 245, the process may facilitate installation, launch and permissioning of the alternative application that fits the user's default permissions model, at 247.

FIG. 3 shows an illustrative PDV creation and initialization process. The PDV is created by the backend process at 301, in response to a user account creation request, for example. This may involve the gathering of some initial user data at 303. This data may be highly specific and confidential, if desired, as the user has control over the privacy of the account and can use the data for, for example, form filling or other digital transactions. On the other hand, users may need to build trust with the PDV provider before sharing certain data, so the initial data may vary by user and/or by provider policy.

Once the PDV has been initialized, the user can add entities at 305. This can include, for example, express addition of user accounts, such as user specified banks, credit cards, email services, map services, shopping services, search engines, social media accounts, etc. The user may be presented with a list of selectable entities, which may include entities already participating with the PDV system Or the user could key in portions of entity names to search for the entities and select the correct entities at 321.

Additionally or alternatively, the process could scan user email and devices at 323 and determine a likely list of possible entities for inclusion, which could be based on account emails and applications installed on a mobile device. This may include entities already participating with the PDV and entities not yet participating. If an entity chooses to use the PDV for data access, the entity may function in concert with the PDV and likely has defined data policies stored with a central PDV system. If the entity refuses to use the PDV system or is simply unaware of the system, the PDV may attempt to create a policy for the entity. If unsuccessful, as noted in FIG. 2, the application may still be able to function on the mobile device, but may be unable to access the PDV of the user until the developer has worked with the PDV to obtain a general policy or a policy for that user.

Once the accounts and devices have been scanned at 323, the process may present the user with additional entities to add. These entities are added to the PDV in the sense that they have permissions and/or policies for accessing the PDV defined by the user's PDV. That is, once added and permissioned, the given selected entity can access the PDV at the defined access level. A user may not want all app developers providing all applications on the user's phone to access their PDV at any level, and so may choose to only select highly trusted or highly valuable applications at 327 for permissioning and for whom access to the PDV will be granted at the level defined for the respective entity.

For each entity selected at 327, the process may attempt to find and analyze data request policies at 329. For entities having relationships with the PDV central system, either voluntarily or because of other PDV users granting access to the same entity, there may already be existing data request definitions in place in the central system, detailing what data that entity tends to request and how the entity uses and retains the data. Analysis of those data requests will likely be easier than analyzing a fresh policy for a new entity.

As shown in FIG. 2, for each entity a policy or proposed hybrid policy can be defined. Since the entities are potentially being processed in a batch in this example, the user may be shown a list with each entity name and the level of access requested. The user can selectively grant or deny the requested level to each entity. The process may also show out of bounds (OOB) alerts at 333, where an entity requests unexpected or highly confidential data, which may be a sign that the entity is a risky addition at the requested policy level. For example, a video game application requesting level four secure access is probably an improper request, and the user can reject the request and disable the application if desired. The user may also modify applied policies at 335, which can include acceptance of any proposed hybrid policies displayed at 309, modification of classifications of certain data at 311, and modification of data sharing to exclude certain OOB parameters from an entity (which may or may not result in termination of the services with that entity if the entity disagrees with the modification). Then, permissions for each entity can be set at 313 in accordance with user desires.

The user may also configure default permissioning at 307, which can either include accepting a recommended default (e.g., level 2) and default classification of data as best determined by the PDV system. Acceptance will set a base default at 308, but the user could change this at any time.

If the user wants to define default permissions, the user can be shown the possible options at 309, which can include permission levels, data type classification, etc. The granularity of control may be up to the user, who could assign broad categories to a policy tier or who could granularly assign data types to a policy tier. Once a user changes data to tier assignment, it may make more sense for the user to set the default policy, as the recommended default may encompass or fail to encompass certain data based on the user reclassifying the data within their own accounts. The user may also be able to create additional policy tiers in this manner, so while a default number of tiers may be four, a specific user may have, for example, fifteen tiers of policy.

The user may also be given the option to install a watchdog process or plug-in at 315, which can be a background process that monitors on-device data gathering and alerts the user when unpermissioned applications are gathering data and/or when a given application should or could be added to the PDV access permissions. The user could select any number of devices for installation of the watchdog at 317, and the process could install or activate the watchdog process on the requested devices. The user may be required to login or otherwise link a device to the PDV prior to this activation.

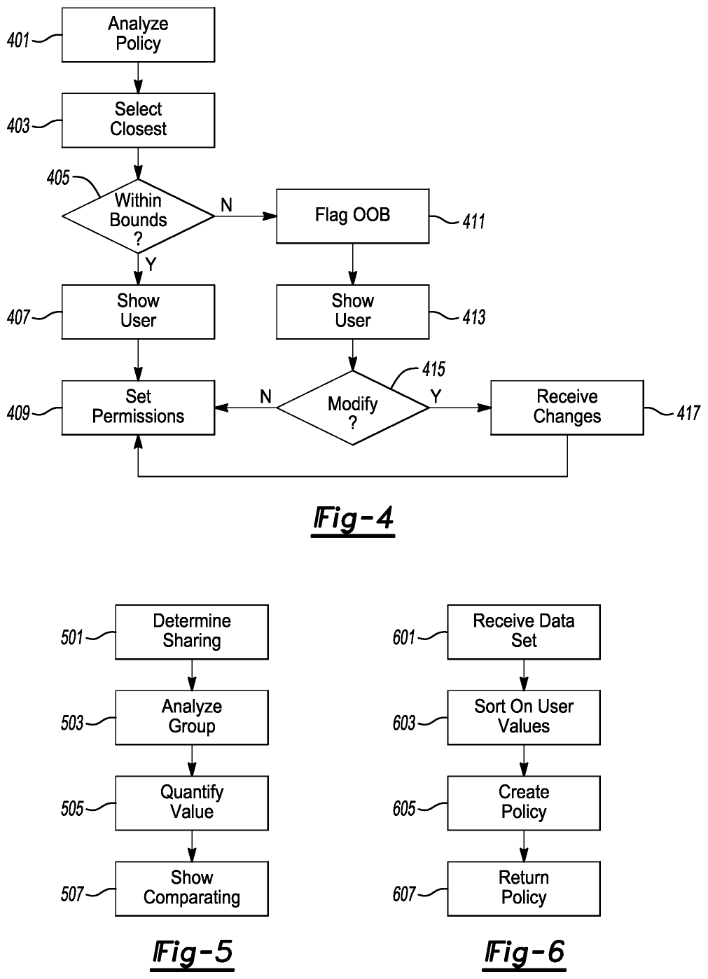

FIG. 4 shows an illustrative process for policy analysis. In this example, the process attempts to analyze a written data policy, which may include a list of data types requests, usages intended and retention desires. Assuming the written policy contains sufficient detail for analysis, the process can review the policy through an AI application and select a closest policy of the user's that corresponds to the proposed data gathering for the application at 403. As noted before, this will typically be the selection of the most restricted tier policy to which the data corresponds, since that level of access will be required to obtain the full requested data set.

The user may also have specific carveouts of data that is not commonly shared, or the policy analysis engine may be able to classify what is “standard” for applications of a certain nature, and the process can determine if any requested data, usages or retention intentions are not within user preferred or standard boundaries. For example, all navigation applications may commonly request destination, location and fuel purchase data, but one application may also request online shopping data, which may be flagged as out of bounds at 411 because it is an outlier request or because a user preference not to share that data with anyone has been triggered.

The user can be shown any out of bound requests associated with the policy at 413, and be given an opportunity to grant the request, accept a modified hybrid policy for that application, or modify the permissions to simply exclude that portion of the requested data, at 415. Once any changes are received at 417, the policy can be set.

If all requests are in-bounds, the user may be shown the proposed policy informationally at 407 and upon acceptance (or automatically), the policy for that entity may be set at 409. Automatic permissioning for entities with reasonable requests may incentivize entities to keep their requests to those of a reasonable nature.

FIG. 5 shows an illustrative example of a data-sharing analysis process. This is an informational process that can be useful to both users and developers, wherein a policy is analyzed for value so that users can understand a value for data exchange and developers can understand if their data requests are reasonable relative to their value provided. Further, the value may vary by user, but since the PDV may be able to classify a great deal of user behavior based on aggregated data, it may be possible to quantify the value of an application or service to a particular user, who can then determine if a data sharing request is reasonable.

For example, if an application provided fuel discounts, but was very aggressive in data gathering, a user who worked from home and traveled 20 miles a week may barely benefit from the fuel discounts. On the other hand, a user who traveled 200 miles a day may be willing to share virtually any information in exchange for a reasonable discount.

The value analysis process could determine what data is being shared at 501 and assign a relative value to that data. The value could be based on, for example, the average monetary or rewards-style value obtained by users in exchange for comparable data, over a wide set of users. Additionally or alternatively, the value could be determined based on comparable services and their value relative to data requests.

The process devises a group of users, data and applications for comparative analysis at 503. This works best if the PDV is responsible for handling value exchange, as it can record value received for data exchanged and thus accurately determine the value of the exchanges. But, even if the PDV simply knows the proposed values of a given comparable application (e.g., 2 percent discount on all fuel) and the travel and fuel purchase habits of each user in the group, the PDV can reasonably determine the value for data.

The process can determine that a proposed value of 4 percent discount for the current application is high relative to peer applications, and that the quantified value at 505 for that user is approximately $15 per week. Based on the additional gain of $7.50 per week over the comparable, the requested additional data may be worth the exchange. The process can also compare what value is usually given for the additional data (based on other applications requesting the data in exchange for value).

The user can be shown the comparative values, as well as a value-based analysis at 507, that effectively informs the user whether the value is “fair” (comparable to market rates for that data and/or comparable to what others receive for the data). The analysis can be both in terms of the raw offer and the direct value to the user. As noted above, the stay-at-home user derives almost no real value from the particular offer, and so would probably not receive the same conclusion on analysis as the user traveling 200 miles a day, but each user could thus make an informed decision about the value exchange and only permit data sharing that maximized their particular user value based on their own personal behavior.

FIG. 6 shows an illustrative example of an alternative policy creation process. This process creates a custom policy for each entity or developer, based on a data set provided by the developer. That is, instead of analyzing a written policy provided by the developer, the developer submits a sample data request and is given access to the data corresponding to the request (e.g., the types of data) based on a policy created to encompass that data.

This has a benefit for the user because the user does not have to rely on policy language analysis which may include obtuse or vague word usage (e.g., “location data”) and further prevents access to data not included in the express request. That is, instead of granting access to “all tier three data,” the developer may be granted access to only the specified tier three data that is included in the sample data set. This may also incentivize users to accept requests, because the access granted to an entity is more limited in this sense.

This is also beneficial for the PDV system, because it can observe the specific types of data requested, know to gather that data for other users because at least one application or entity wants that data, and better know the “fairness” and value of the specific requests, as well as avoid misunderstandings of written data policies that vaguely word intentions.

Developers may also be incentivized to participate in such a process, because it may lead to greater acceptance of their data policies. While this may require them to reveal what data they are gathering, the world is headed in that direction in any event, and developers want to appear that they are playing within the bounds of the current social norms. Accordingly, transparent developers may have much greater success in gathering the data they actually care about, and may be somewhat agnostic about the rights to gather additional data of no particular immediate relevance to them.

For a given developer, the PDV analysis process can receive a data set sample at 601. This may be stored in a repository associated with that developer, so that future requests by other users to add that entity to a permissions list can result in access of the received data set for policy definition purposes—i.e., the developer may only have to submit the sample once, unless the needs or desires change. The initial set may have been submitted by the developer to aid in the policy creation process.

This set can also include retention indicators, use indicators, etc., so it effectively becomes a snapshot of what written policy language is intended to encompass. The set can also be used to train an AI/ML policy analysis process in better understanding the correlation between any written policy and what that policy is actually intended to encompass.

For a given user seeking to add the developer (or corresponding app), the process can correlate the requested data (from the sample set or stored template based on the sample set) to the user-defined definitions of what data falls under what policy for that user. That is, while many users may accept default policy-to-data-type correlations, some users may customize what data falls under what tier of policy control. By cross referencing the requested data types against the user's defined policy tierings for those data types at 603, the process can create an applicable policy level for that user at 605.

The system may also store a default template policy for the developer/app, such that if a user shows no reclassification of data (i.e., has not changed a base data definition to a new policy tier), then the default policy built upon the first submission of data would apply.

For example, user 1 uses a default policy mapping provided by a service provider providing the PDV. The service provider correlates basic coordinate location data at tier 1 (least restricted) and online shopping habits as tier 3. A base data set request received from a developer, defining the data that the developer would like to gather, indicates that the developer wants to gather coordinate data and online shopping data. This would be classified as a tier 3 policy, because the most-restricted data requested is tier 3 data. All users using default policy assignments for data types would treat this as a tier 3 permissions request to apply a tier 3 sharing policy to that developer or app.

User 2 may have manually reclassified online shopping data as tier 2 data, being more willing to share that data, or being unwilling to grant general tier 3 access to apps requesting online shopping data, but not caring as much as to whether that specific data type was more freely available as tier 2 data.

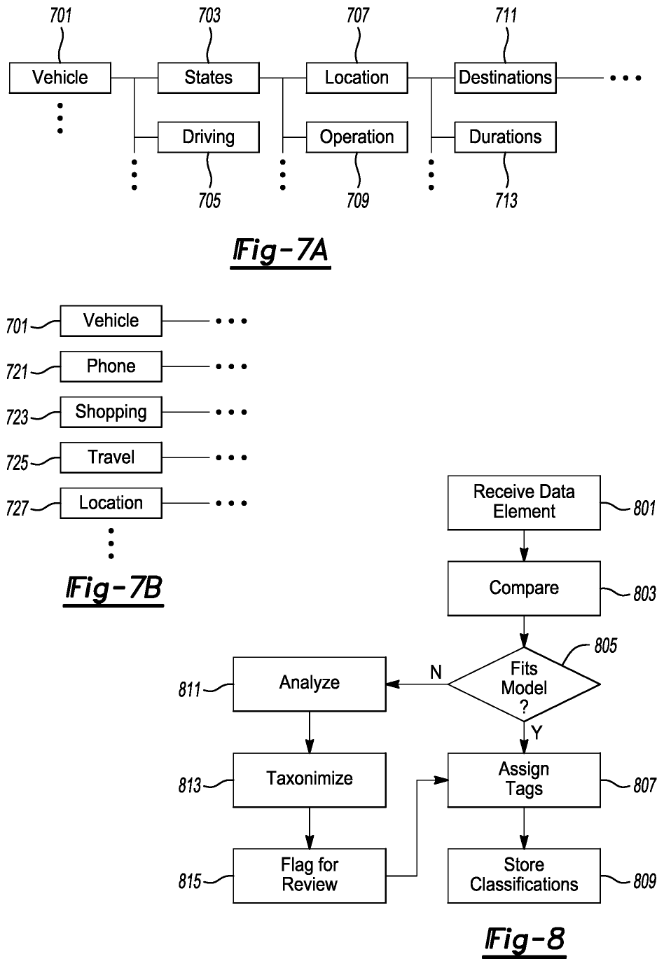

It is worth noting that, under a fixed policy system wherein permissions are tied to policy levels (e.g., an entity/developer/app is granted tier X permission), it may be possible to request any data at that tier, not just the data on which the tier X gran was based. Accordingly, some users may reclassify commonly requested data to a lower tier, not wanting to forego the use of services requiring the data in exchange for use, but also not wanting to grant the higher default tier of access to all such services. This will be addressed in greater detail with respect to the data taxonomy discussed herein, with respect to FIGS. 7-9.

In this example, once the policy is defined in accordance with the user classification of the requested data types reflected in the received sample, the process can create a proposed policy. This can include a flat policy tier level (e.g., tier 2 access), or can include a hybrid policy with a carveout for the higher tier data type (which is another way of preventing entities from accessing more than specifically requested sensitive data). A hybrid policy above for User 1 might be—full tier 1 access and limited tier 3 access limited to requests for online shopping data only, and no other tier 3 data. It may also be easier to create such hybrid policies if the data types are demonstrated in a request, because it may be easier to carve out specific data from the PDV when the actual data type that will be requested is known.

That is to say, if the policy were derived from AI analysis of a written policy, the PDV provider may have to provide broader Tier X access in order to ensure that it did not misinterpret the policy and deny the developer some data that should have been appropriately provided under the agreement with the user. But, when the developer submits a sample data type request, showing exactly what data is required, the system can be sure that a carveout of a higher tier policy, to create a hybrid policy, includes at least the specifically identified data type. This ability to carveout exceptions would address any proposed concerns of user 2 above as well, since in the example that user downgraded the security of online shopping data to avoid broadly sharing other tier 3 data with many apps and developers. If that user knew that those entities would only receive isolated tier 3 data (i.e., the online shopping data and not other tier 3 data), that user would not have had to downgrade the privacy level of the online shopping data.

FIG. 7A shows an illustrative data taxonomy. One proposed approach to dealing with data classification and policy structuring is to taxonomize all known data types into classifications that can be used to tag data with metadata tags. For example, vehicle data 701 may include subtypes states 703 and driving data 705.

State data may include subtypes location state data 707 and operational state data 709. Location state data may include subtypes destination data 711 and duration at location data 713. These categories can expand along downward or rightward branches are non-limiting in example. But, as can be seen, someone asking for “vehicle data” in a written policy can mean a vast number of different things. Using a sample data request, as suggested in FIG. 6, allows for a more specific understanding of what data is being requested.

A taxonomy further allows for unification and standardization among disparate developers, by defining labels for data that is to be requested. Base taxonomy examples are shown in FIG. 7B, including, but not limited to, vehicle 701, phone 721, shopping 723, travel 725, location 727, etc.

When a developer seeks to gather data from a user, through the PDV, for example, the developer could use an application that shows expandable tree lists with selectable tags. For example, if the developer wanted all vehicle data, they could select the vehicle tag 701 (via a checkbox on an interface, for example). Or they could use an API that defined a data request in terms of labels, such as Data_Request(Vehicle.All). Another developer might only want state data, and so could define the request as Data_Request(Vehicle.States.All) Through standardization, it can be assured that developers all clearly define their requests.

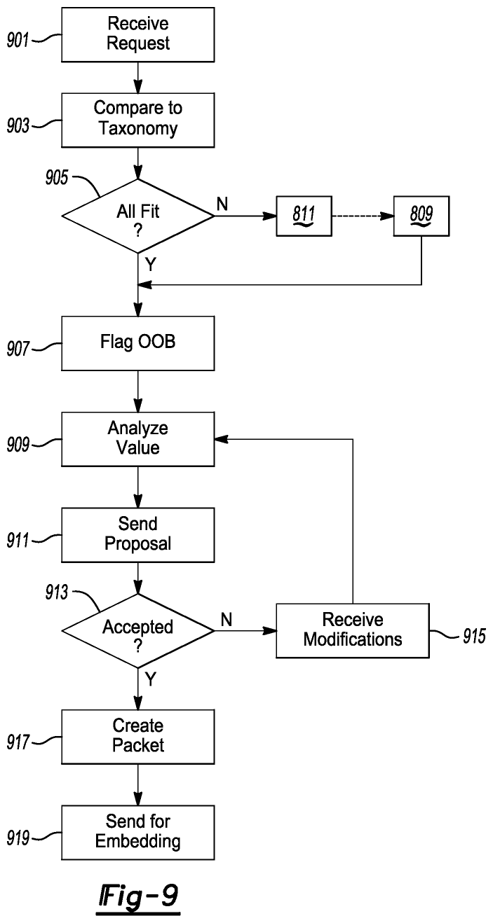

Potentially problematically, however, is the fact that even with limited data, there may be thousands of applicable tags and classifications. It would be very difficult for a developer to learn all of the applicable tags, and so a graphic interface with expandable and selectable tree elements could be provided. Or, as shown in FIG. 9, the received data request could be used to correlate the taxonomy elements to a specific data request, so that by submitting the actual data elements requested, the developer is returned with the correct data request to be embedded in their code.

Users could also expand taxonomy trees to reclassify or block certain data types. A user interface could allow for disabling certain data. The interface may also show a classification (e.g., tier number) associated with each data type, and could allow for fast reclassification by changing the tier number. The interface could also include a drop-down that shows all entities currently requesting and using any specific data type. For example, a user could expand from vehicle to states to location on their interface and see that eleven applications are currently using this data, classified as tier 2 data. The user could deselect any entities, block the data type (disallowing all entities), etc.

Changing permissions in an active agreement may void the agreement (e.g., render the application unusable), and the process could notify the user that they may lose services of entity N or Application M. Nonetheless, the user could visually change permissioning for any identified and stored data type with much greater granularity, using this system, as well as see exactly what data is being used by whom.

FIG. 8 shows an illustrative example for a classifier. Creating a taxonomy will require some analysis of data, both existing and newly received. For example, five washing machine manufacturers of smart washers may provide use-data. Each may give a value differently such as A_Machine (Use.Time=75; Use.Water=40; etc.); B_Machine(Runtime=75; WaterUse=40); etc. Even though the values may correlate to the same information, the data type gathered from a manufacturer would be different in the example (Use.Time vs. Runtime). The classifier would attempt to unify this data as Applicance.Washer.Use.Time data (for example), and store it as such. No matter how the data was formatted, the classifier could translate the data into a corresponding unified PDV value fitting the taxonomy and sort the data accordingly. Then if another developer requested such data, there would be no confusion or requirement for the developer to specify the data types collected from each disparate washing machine.

At some point, manufacturers may even adopt the taxonomy, or pre-submit data to be reported for classification code as in FIG. 9. That is, instead of using the process of FIG. 9 to standardize a data request, the process could also be used to standardize a data report. A manufacturer could submit the literal values or types to be reported (in that manufacturer's own nomenclature) and the process could return standardized meta-data tags to be appended to the data for reporting to the PDV, which would save overhead on the PDV processing and ensure the data was correctly stored and classified within the PDV.

In FIG. 8, the process receives a data element at 801 and compares it to the existing taxonomy at 803. For example, the process receives a data element labeled WasherWeeklyRuntime and determines that this corresponds to an already existing element Applicance.Washer.Use.Time in the current taxonomy at 805, as such type of data had already at least once been classified and thus has a category. Any appropriate meta-data tags can be assigned at 807 and the data can be stored within the PDV at 809.

Certain data can have more than one tag, and much data can have many tags. For example, if the values received were HotWaterUse=30 and ColdWaterUse=10, classifier might classify this as water usage, hot water usage, energy usage, wash preferences, appliance efficiency, washing machine use, appliance use, etc. Cold water use may not receive an energy use tag, but otherwise both types of data could receive at least those metadata tags, and a combination of the data (representing overall water use) may also be stored and receive at least some of those tags. Accordingly, newly received data types (those not yet classified from a source) may both fit and not-fit a current taxonomy. Aspects that fit within the taxonomy may be tagged with existing tags, and the process may further analyze the data at 811 to determine if new taxonomy elements should be created.

For example, if the only existing data tags pertained to overall water usage, receiving the data as disparate hot and cold usage elements may result in creation of at least two new taxonomy tags corresponding to Appliance.Washer.Use.Water.Hot and Applicance.Washer.Use.Water.Cold at 813. Intelligent ML processes can be used to sort data and determine likely appropriate new tags, and some data may be stored in a repository for human review, if the classifier is unable to assign any tags to the data. ML processes may also retroactively assign tags, if the ML classifier improves and is able to better classify or reclassify data. If the data is not stored in a raw format, however, retroactive classification of data may be difficult, if the PDV homogenized the different data into a unified format representative of similar data from different sources.

For example, an early-phase classifier may simply combine the water usage data and save it as net water usage. As the classifier improves, it may be able to assign new tags to the hot and cold water usage elements of the data and, moving forward, append the additional tags to the specific types of data, as well as store net usage data. But, retroactively, if the classifier had simply homogenizied HotWaterUse as Applicance.Washer.Use.Water and ColdWaterUse as Applicance.Washer.Use.Water, then it would be difficult to retroactively tag the data, as the data would have lost the differential characteristics it had when received. If the raw data was available, however, then the classifier could retroactively tag the data elements with the new tags.

In some instances, retroactive tagging can be done without recourse to raw data. For example, if a new tag of Applicance.Water.Use (which would contemplate all water used by ANY appliance, not just washers) were added, then it would be possible to add this tag to all appliances that already existed for which water use data was stored. In this example, the data tags are added as meta data to, for example, aggregated data (such as a daily, weekly, monthly, etc. total) for data and/or individual recorded instances of such data stored as discrete elements. Tags may have variable aspects as well, defining bounded parameters such as time or date, and a request for all data may include a bounded time or data parameter that would also be appended to the data as a meta data tag (which can include a range for data having more than an instantaneous duration, such as locations during a trip).

Newly classified data may also be flagged for review or comparison at 815, which may result after a certain number of instances of that type of data had been received. Raw data that receives tags based on ML analysis may all be saved in respective PDVs until a review has confirmed the appropriateness of the tags, even if raw data (in the format in which it was received) for all received data is not stored due to space constraints.

FIG. 9 shows an illustrative example of a process that can define an embedded data request in a consistent format for standardization of requests, as well as assist in a value proposition. In this example, the developer or application may submit a raw data request that includes the specific data elements in which they are interested. Because the taxonomy may be large, the developer may not know the entire tree, and so may choose to use plain language nomenclature to define what data is requested—e.g. (Washing Machine Usage Data—Water, Temperatures, Runtime; Vehicle Data—Locations, Durations, Key On Times, Key Off Times).

While the request is not in taxonomical format, such a request can be analyzed by an ML processor. Results data (i.e., previously received data responsive to requests outside the PDV) may also be provided by the developer. For example, prior to the existence of the PDV, the developer may have had to poll washing machines separately, and can provide samples of the received responses. If the classifier has already seen this type of data (as part of data being reported to the PDV), then the classifier should be able to easily classify the element of the request. So, for example, if the developer submits (Use.Time=75) then the classifier may recognize this as data which it classified as Appliance.Washer.Use.Time data at 903 and may add that data type to a proposed policy.

Each meta-data tag can be added to the policy and the policy can be assembled so that the developer has a specifically curated policy defining rights for each data type (with user permission), and cannot access additional data without specifically requesting it. This allows for custom policy creation with low overhead on the developer and low overhead on the PDV provider once the classifier has been running for a while and has developed a robust taxonomy. Each developer can simply submit sample data requests and have a curated and custom request defined for embedding as a data gathering policy. Then, when a watchdog application or user adds the developer's application to the PDV access, and analyzes the policy, it will be analyzing the policy crafted specifically for cross referencing with the PDV and existing user permissions for data of all types stored in the PDV. The developer, assuming they want the data from the PDV, will not have to learn the whole taxonomy, and can simply use a tool to develop the custom request in the correct formatting. The PDV providing entity can benefit from being given samples of all pertinent data requests and avoiding misunderstanding of plain language terms in a written policy. The user can see exactly what data is being requested and used, and can further granularly control the data, as well as know that each developer only has access to the specific data they need, until they request new types.

Once all the data in the request has a tag or proposed tag (added by a classifier process), the process can flag certain data as out of bounds at 907. That is, for example, if all data types requested are low-security data types (e.g., tier 1) and there is a single tier 4 request, this may seem out of bounds with regards to the type of request and/or the type of requestor. Some of the analysis leading to this conclusion can be based on intra-set analysis, other analysis can be based on developer-type analysis or other group-based analysis comparing the request to those of similar entities.

While the taxonomy provides specific, easy to understand, meta-data tags for appending, it can work in conjunction with a tiering policy system as well. For example, the tiers can still be representative of privacy levels, and entities can still be granted full access to a tier. The tier value can be appended as meta data, and users can reassign the tier value for any element of the taxonomy. The taxonomy simply additionally allows for crafting curated and entity specific policies that limit data usage to elements specified, but an entity may still be granted full tier access to any tier and/or a hybrid policy may include full tier one access (all data with tier one appended thereto) and a specific tier three data set (data with the specific data type appended thereto).

The process shown in FIG. 9 analyzes the value of the requested data. While done on behalf of the developer here, the same analysis can be done for a user if the user seeks to add this application to a policy table in the user's PDV. One point of providing the value analysis to the developer is to help gain acceptance of the application by users, if the value offered is not sufficient in terms of the common value of the data requested, the developer may have to request less data or provide more value. A developer may have little to no idea about the relative value of their services or the excessive nature of their data requests, and this process can help tune data requests and value propositions to be in line with user expectations.

The process may send any proposed modifications to the developer at 911, which can include revisions to data requested that may make it more likely for users to accept the data request as part of using the application. While it may be difficult for a backend ML process to quantify the value of a particular application, the ML process may recognize that, for example, video game applications are usually accepted if they request data types A, B and C, food delivery applications are usually entitled to A, B, C and D, etc. So a developer asking for A, B, C and D, but providing a video game, may be suggested to remove D. The developer does not have to accept the proposal at 913, and can input an alternative proposal at 915, but the backend analysis may inform the developer to better ensure a data request that is user friendly and in line with user expectations.

While a developer may initially refuse to remove the request for element type D in the example above, the developer may come to appreciate that similar analysis is being provided by users who use the application in conjunction with a PDV. That is, the users may be being told that this video game, unlike other video games, is requesting and using additional user data and should provide additional value in exchange. Users may refuse access to the PDV, or selectively remove element D from the permissions table, etc., and the developer may either change the request or add additional value to the user in exchange for D (e.g., an in-game reward, for example).

Once the developer agrees to a certain request type at 915, the process creates a packet or script or formatting at 917 and sends it to the developer at 919 for inclusion with the application. Since the example uses a taxonomy, it can be a fairly small snippet that is included in the code. For example, each data type in the taxonomy could have a value, and the full request could be represented by 1.23.334.335.34453—wherein data types 1, 23, 334, 335 and 34453 are requested. The fact that the types are included in the request does not guarantee acceptance, this instead merely provides a unified request type for fast analysis, fast cross reference and assurances that the user is not being tricked into agreeing to a request that is really more than it seems.

While the taxonomy or other unified classification is not necessary, it can make the process of unifying many disparate requests and data types much easier.

The entire set of illustrative examples, and the like, provide illustrations of how policies can be imported, initiated, crafted and customized to present an approach allowing for permissioning of hundreds or thousands of entities and accounts with which a user may interact, which in turn would want access to unified user data. Approaches include low overhead and low user-impact addition of policies and on-the-fly request and policy handling, and users can have assurances that entities provided with controlled access to a unified data store have that access carefully controlled in accordance with prior agreements and existing and defined policies. Those policies can be changed and granularly controlled, and users can see types and specifics of data being requested, obtain more value for their data, and exercise better control over their whole data profile.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. As such, embodiments described as less desirable than other embodiments or prior art implementations with respect to one or more characteristics are not outside the scope of the disclosure and can be desirable for particular applications.

What is claimed is:

1. A system comprising:
one or more processors configured to:
receive a request to add one or more permissions for a third-party entity to access a privacy vault associated with a user;
determine one or more types of contents that are stored by the privacy vault and that the third-party entity intends to access, the determination based on identification, by the third-party entity, of the one or more types of contents;
define a permissions policy, applicable to the third-party entity, defining permissions relating to access of contents and that encompasses at least permissions relating to access of the one or more types of contents;
determine whether the permissions policy falls within user-defined guidelines for automatic acceptance of new permissions policies; and
present the permissions policy to the user for acceptance or modification, responsive to the permissions policy falling outside the user-defined guidelines.

2. The system of claim 1, wherein the identification of the one or more types of contents is provided in an entity usage agreement provided by the third-party entity and wherein the one or more processors are further configured to analyze the usage agreement to determine the one or more types of contents.

3. The system of claim 1, wherein the identification of the one or more types of contents is provided via the entity by a representative contents request provided by the third-party entity.

4. The system of claim 1, wherein the identification of the one or more types of contents is provided via the third-party entity by express identification of specific contents elements the third-party entity intends to access.

5. The system of claim 1, wherein the identification of the one or more types of contents is provided via a predefined packet identifying specific contents elements that the third-party entity intends to access defined in a predefined format recognizable by the one or more processors.

6. The system of claim 1, wherein the determination of whether the permissions policy falls within user-defined guidelines is based at least in part on one or more characteristics of the third-party entity correlated to user-defined guidelines defining automatically acceptable new permissions policies for third-party entities having the one or more characteristics.

7. The system of claim 6, wherein the one or more characteristics include a type of business of the third-party entity.

8. The system of claim 1, wherein the user-defined guidelines identify classes of contents having varied security levels associated therewith, and wherein definition of the permissions policy includes access to contents at or below a most-secure level associated with at least one of the one or more types of contents.

9. The system of claim 1, wherein the user-defined guidelines identify classes of contents having varied security levels associated therewith, and wherein definition of the permissions policy includes access to contents below a most-secure level associated with at least one of the one or more types of contents and further includes access to specific contents at the most-secure level limited to specific types of contents based on the identification of the one or more types of contents.

10. The system of claim 1, wherein the user-defined guidelines identify types of contents accessible by types of business associated with third-party entities, and wherein definition of the permission policy includes access limited to the specific one or more types of contents identified by the third-party entity.

11. A method comprising:
receiving a request to add one or more permissions for a third-party entity to access a privacy vault associated with a user;
determining one or more types of contents, stored by the privacy vault, that the third-party entity intends to access, based on identification of the one or more types of contents by the third-party entity;
defining a permissions policy applicable to the third-party entity defining permissions relating to access of contents and that encompasses at least permissions relating to access of the one or more types of contents;
determining whether the permissions policy falls within user-defined guidelines for automatic acceptance of new permissions policies; and
presenting the permissions policy to the user for acceptance or modification, responsive to the permissions policy falling outside the user-defined guidelines.

12. The method of claim 11, wherein the identification of the one or more types of contents is provided in a third-party entity usage agreement provided by the third-party entity and wherein the one or more processors are further configured to analyze the usage agreement to determine the one or more types of contents.

13. The method of claim 11, wherein the identification of the one or more types of contents is provided via the third-party entity by a representative contents request provided by the third-party entity.

14. The method of claim 11, wherein the identification of the one or more types of contents is provided via the third-party entity by express identification of specific contents elements the third-party entity intends to access.

15. The method of claim 11, wherein the identification of the one or more types of contents is provided via a predefined packet identifying specific contents elements that the third-party entity intends to access defined in a predefined format.

16. The method of claim 11, wherein the determination of whether the permissions policy falls within user-defined guidelines is based at least in part on one or more characteristics of the third-party entity correlated to user-defined guidelines defining automatically acceptable new permissions policies for third-party entities having the one or more characteristics.

17. The method of claim 16, wherein the one or more characteristics include a type of business of the third-party entity.

18. The method of claim 11, wherein the user-defined guidelines identify classes of contents having varied security levels associated therewith, and wherein definition of the permissions policy includes access to contents at or below a most-secure level associated with at least one of the one or more types of contents.

19. The method of claim 11, wherein the user-defined guidelines identify classes of contents having varied security levels associated therewith, and wherein definition of the permissions policy includes access to contents below a most-secure level associated with at least one of the one or more types of contents and further includes access to specific contents at the most-secure level limited to specific types of contents based on identification of the one or more types of contents.

20. A system comprising:
a user privacy vault storing a plurality of types of user contents gathered from one or more devices of a user; and
one or more processors configured to:
receive a request to add a plurality of permissions granting access to the privacy vault for a plurality of third-party entities;
for one or more of the plurality of third-party entities:
analyze information provided by a given of the one or more third-party entities, indicating what contents, of the user contents, the given third-party entity intends to access;
define a new permissions policy for the given third-party entity based on the analyzing;
determine if the new permissions policy corresponds to user-defined guidelines for automatic acceptance of a permissions policy;
store the new permissions policy, responsive to the new permissions policy corresponding to the user-defined guidelines;
present the new permissions policy to the user for acceptance or modification, responsive to the new permissions policy failing to correspond to the user-defined guidelines; and
repeat the analysis, definition of the new policy, determination of correspondence to guidelines and storing or acceptance for remaining ones of the one or more third-party entities.
